(19) United States
(12) Patent Application Publication
(10) Pub. No.: US 2026/0210879 A1
(43) Pub. Date: Jul. 23, 2026

(54) Method and system for guided parameter selection in x-ray microscope

(71) Applicant: Carl Zeiss X-ray Microscopy, Inc., Dublin, CA (US)

(72) Inventors: Hauyee Chang, Concord, CA (US); Naomi Kotwal, Livermore, CA (US); Justin Hanlon, Dublin, CA (US); Meow Tan, Livermore, CA (US); Robin White, Vancouver (CA); Brian Smyth, San Francisco, CA (US); Gerhard Krampert, Pleasanton, CA (US); Anke Dutschke, Aalen (DE)

(21) Appl. No.: 19/157,794

(22) PCT Filed: Feb. 26, 2024
(86) PCT No.: PCT/US2024/017202

§ 371 Date: Aug. 19, 2025

Related U.S. Application Data
(60) Provisional application No. 63/487,064, filed on Feb. 27, 2023.

(51) Int. Cl. G01N 23/046

(52) U.S. Cl. CPC G01N 23/046

(57) ABSTRACT

An X-ray microscopy system provides guided acquisition parameter selection. Specifically, a computer projections from the detector subsystem and generates a user interface for guiding a user to select acquisition parameters for the projections.

### RELATED APPLICATIONS

This application claims the benefit under 35 USC 119(e) of U.S. Provisional Application No. 63/487,064, filed on Feb. 27, 2023, which is incorporated herein by reference in its entirety.

### BACKGROUND OF THE INVENTION

X-ray analysis is a powerful imaging modality for analyzing internal structures on the millimeter, micro to nano scale. X-ray systems provide high resolution images of samples, allowing for detailed study of their properties. X-ray systems use a beam of x-rays to illuminate the samples, which is then imaged using a detector. The x-rays are then analyzed to produce an image or projection of the sample.

X-ray computed tomography (CT) is a non-destructive technique for converting the projections from different angles into three dimensional (3D) volume of the sample. Tomographic volume data sets are reconstructed from a series of these projections via standard CT reconstruction algorithms, as the samples are scanned at different angles. There are a number of different configurations for x-ray CT systems. In x-ray microscopy (XRM) and industrial CT systems, because the x-ray sources and detectors are large and the samples or objects being scanned are typically small, the x-ray sources and detectors are largely fixed, while the samples are rotated in the x-ray beam. The opposite is true of medical x-ray CT systems in which the patient is stationary and the source/detector rotate around the patient.

Acquisition parameter selection is an important part of operating x-ray systems. The X-ray source voltage and filter selection determine the penetration and absorption of the x-ray beam by a sample and the resolution of the images of the sample. The camera exposure time and number of frames can be adjusted to optimize the contrast, and the overall number of projections can be adjusted to get the most information from the sample. Overall, parameter selection is critical to ensuring that the images produced are of the highest quality and achieve the users'objectives.

Currently users are given a protocol to follow manually facilitate parameter selection by XRM system manufacturers. Often the systems provide a series of guidelines to the user to assist in the selection.

### SUMMARY OF THE INVENTION

A major challenge for X-ray systems and specifically X-ray microscopy users is the determination of acquisition parameters for a given XRM system, sample and region of interest. Among other things, users must consider which motion controller axis should be used to move the sample out of the way for taking reference images, X-ray source voltage, X-ray source filtration, camera exposure time, number of frames, and overall number of projections. Each of these acquisition settings can affect image quality and there is often a tradeoff between throughput and image quality. Note that when using flat panel detector, for example, it is common to take multiple frames per exposure and average them together before saving the image. The optimum number can be a function of binning.

This invention concerns the use of software to automatically guide and suggest acquisition parameters to users.

In general, according to one aspect, the invention features an X-ray system, such as XRM system, with guided and possibly automatic acquisition parameter selection. This system comprises an X-ray source subsystem of generating X-rays, an object stage subsystem for holding, moving and rotating a sample in the X-rays, a detector subsystem for detecting the X-rays after interaction with the sample, and a computer for receiving images from the detector subsystem and generating acquisition parameters for the images.

In particular, the system typically generates a user interface for guiding a user to select acquisition parameters for the images.

Typically the user interface generated by the computer guides the user to capture one or more reference images and/or to capture one or more sample images.

Currently, the images are captured at different X-ray source subsystem acceleration voltages and different filters.

The computer analyzes the one or more reference images without a sample in the field of view and-if captured-the one or more sample images to generate suggested acquisition parameters. Preferably, the computer suggests several sets of acquisition parameters, providing different options with differing tradeoffs between throughput and quality of the final results.

In general, according to another aspect, the invention features a method for guided acquisition parameter selection in an X-ray microscopy system.

This method comprises generating X-rays, detecting the X-rays after interaction with a sample, a computer receiving images and generating a user interface for guiding a user to select acquisition parameters for the images.

In general, according to another aspect, the invention features a user interface rendered on a display of a microscopy system. It comprises controls for moving a source stage and/or object stages and/or a detector stage and a messaging region in which acquisition parameter are suggested.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an x-ray microscopy system to which the present invention is applied in one embodiment; and

FIGS. 2-6 show a user interface generated by the microscope for guided acquisition parameter selection.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

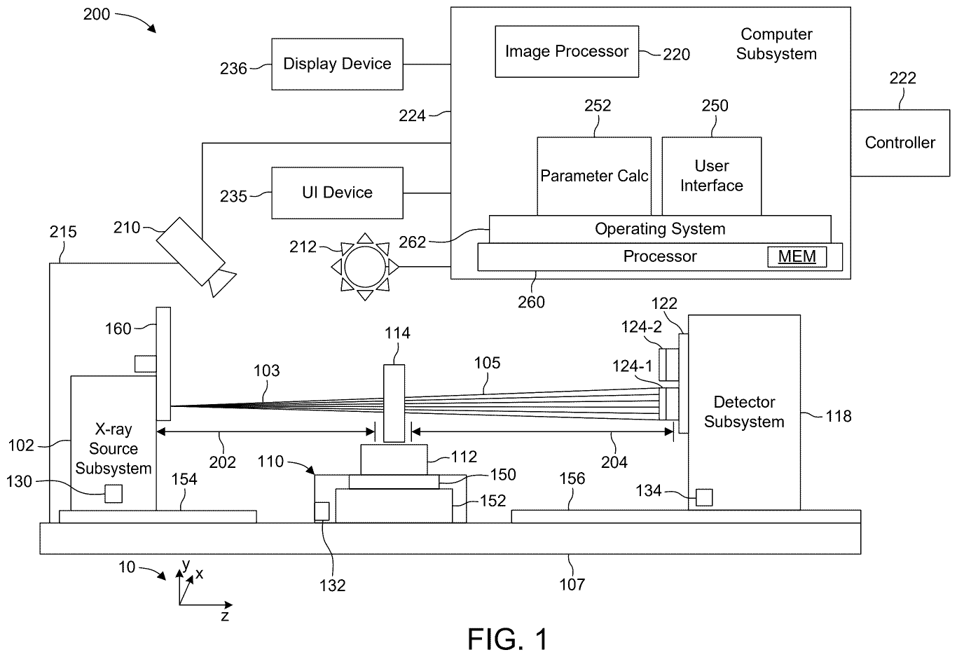

FIG. 1 is a schematic diagram of a XRM system 200 to which the present invention is applicable.

The illustrated microscopy system 200 is an X-ray CT system and generally includes several subsystems. An X-ray source subsystem 102 generates a polychromatic or possibly monochromatic X-ray beam 103. An object stage subsystem 110 with object holder 112 holds a sample or object 114 in the beam and positions and repositions it to enable scanning of the sample 114 in the stationary beam 103, 105. A detector subsystem 118 detects the beam 105 after it has been modulated by the sample. A base, such as a platform or optics table 107, provides a stable foundation for the microscopy system 200 and its subsystems.

In general, the object stage subsystem 110 has the ability to position and rotate the sample 114 in the beam 103. Thus, the object stage subsystem 110 will typically include linear and rotation stages. The illustrated example has a precision 3-axis stage 150 that translates and positions the sample along the x, y, and z axes, very precisely but only over relatively small ranges of travel. This allows a region of interest of the object 114 to be located within the beam 103/105. The 3-axis stage 150 is mounted on a theta stage 152 that rotates the sample 114 in the beam around the y-axis. The theta stage 152 is in turn mounted on the base 107.

The source subsystem 102 will typically be either a synchrotron x-ray radiation source or alternatively a “laboratory x-ray source” in some embodiments.

As used herein, a “laboratory x-ray source” is any suitable source of x-rays that is not a synchrotron x-ray radiation source. Laboratory x-ray source 102 can be an X-ray tube, in which electrons are accelerated in a vacuum by an electric field and shot into a target piece of metal, with x-rays being emitted as the electrons decelerate in the metal. Typically, such sources produce a continuous spectrum of background x-rays combined with sharp peaks in intensity at certain energies that derive from the characteristic lines of the selected target, depending on the type of metal target used.

In one example, source subsystem 102 is a rotating anode (reflective target) type or microfocused source, with a Tungsten target. Targets that include Molybdenum, Gold, Platinum, Silver or Copper also can be employed. Preferably a transmission target configuration is used in which the electron beam strikes the thin target from its backside. The x-rays emitted from the other side of the target are used as the beam 103.

The x-ray beam generated by source subsystem 102 is often conditioned to suppress unwanted energies or wavelengths of radiation. For example, undesired wavelengths present in the beam are eliminated or attenuated, using, for instance, energy filters (designed to select a desired x-ray energy range (bandwidth)) held in a filter wheel 160. These energy filters typically include an ‘air’ filter corresponding to no filter along with a set of low energy filters for filtering lower energy x-rays and high energy filters for filtering higher energy x-rays.

When the object 114 is exposed to the X-ray beam 103, the X-ray photons or particles, which propagate through the sample 114, form a modulated beam 105 that is received by the detector subsystem 118. In some other examples, an objective lens is used to form an image onto the detector subsystem 118 of the microscopy system 200.

Typically, a magnified projection image of the object 114 is formed on the detector subsystem 118. The magnification of the x-ray stage is equal to the inverse ratio of the source-to-object distance 202 and the source-to-detector distance 204.

To achieve high resolution, an embodiment of the x-ray CT system 200 further utilizes a very high resolution detector 124-1 of the detector subsystem 118 and/or with positioning the sample 114 close to the x-ray source system 102. In one implementation of the high-resolution detector 124-1, a scintillator is used in conjunction with a microscope objective to provide additional optical magnification in a range between 2× and 100×, or more. The scintillator converts the x-rays into an optical image that can be detected by a camera.

Other detectors are often included as part of the detector subsystem 118. For example, the detector subsystem 118 can include a lower resolution detector 124-2. This could be a flat panel detector and camera or a detector with a lower magnification microscope objective, in examples. Configurations of one, two, or even more detectors 124 of the detector subsystem 118 are possible.

Preferably, two or more detectors 124-1, 124-2 are mounted on a turret 122 of the detector subsystem 118, so that they can be alternately rotated into the path of the modulated beam 105 from the sample 114.

Typically, the source subsystem 102 and the detector subsystem 118 are mounted on respective z-axis stages. For example, in the illustrated example, the source subsystem 102 is mounted to the base 107 via a source stage 154, and the detector subsystem 118 is mounted to the base 107 via a detector stage 156. In practice, the source stage 154 and the detector stage 156 are lower precision, high travel-range stages that allow the source subsystem 102 and the detector subsystem 118 to be moved into position, often very close to the object during scanning and then be retracted to allow the object to be removed from, a new object to be loaded onto, and/or the object to be repositioned on the object holder 112 of the object stage subsystem 110.

The operation of the microscopy system 200 and the scanning of the object 114 is controlled by a computer subsystem 224 that often includes an image processor 220 and a controller 222.

The computer system 224 includes one or more processors 260 along with their data storage resources such as disc or solid-state drives, and memory MEM. The processors 260 execute an operating system 262 and various applications run on that operating system 262 to allow for user control and operation of the microscopy system 200. Particularly, a user interface application 250 executes on the operating system 262 and generates a user interface that is rendered on a display device 236 connected to the computer subsystem 224. The user interface enables the operator to control the system and view projection images and tomographic reconstructions. User input device(s) 135 such as a touch screen, computer mouse, and/or keyboard enable interaction between the operator and the computer subsystem 124. A parameter calculation app 252 receives user selections via the user interface app 250 along with reference and sample image data from the detector subsystem 118 and determines possible parameters combinations that are relayed back to the user via the user interface app 250.

The controller 222 allows the computer subsystem 224 to control and manage components in the X-ray CT microscope 200 under software control. The controller might be a separate computer system adapted to handle realtime operations or an application program executing on the processor 260. The source subsystem 102 includes a control interface 130 allowing for its control and monitoring by the controller 222. Similarly, the object stage subsystem 110 and the detector subsystem 118 have respective control interfaces 132, 134 for allowing for their control and monitoring by the computer subsystem 224 via the controller 222.

To configure the microscopy system 200 to scan the sample and to adjust other parameters such as the geometrical magnification, the operator utilizes the user interface rendered on the display device 236 and generated by the user interface application 250 to adjust the source-to-object distance 202 and the source-to-detector distance 204 by respective operation of the source stage 154 and detector stage 156 to achieve the desired scanning setup.

Specifically, the source stage 154 and detector stage 156 include respective motor encoder systems or other actuator systems that allow the computer system 224 via the controller 222 to position the respective x-ray source subsystem 102 and the detector subsystem 118 to specified positions via the control interfaces 130, 134. Further, the source stage 154 and detector stage 156 signal the controller 222 of their actual positions.

Prior to performing the CT scan, the operator of the system operates the object stage subsystem 110 via computer subsystem, the controller 222 and the control interfaces 130, 132, 134. Typically, the object stage subsystem 110 will position the object by rotating the object about an axis that is orthogonal to the optical axis of the x-ray beam 103, 105 by controlling the theta stage 152 and/or position the sample in the x, y, z axes directions using stage 150.

Using the user interface rendered on the display device 236 by the user interface app 250, the operator defines/selects scanning set up including the acquisition parameters via the UI devices 235. These acquisition parameters include x-ray source voltage and filter settings that help to determine the X-ray energy spectrum on the X-ray source subsystem 102 and exposure time and number of frames per projection on the detector subsystem 118. The operator also typically selects other settings such as the field of view of the X-ray beam 103 incident upon the sample 114, the number of X-ray projection images to create for the sample 114, and the detector 124-1, 124-2 selected. Generally, the acquisition parameters include X-ray source voltage, X-ray source filtration, camera exposure time, number of frames per projection, and overall number of projections and the scanning setup includes the angles to rotate and position of the sample by the stage subsystem 110. In addition, the source-to-object distance 202 and the source-to-detector distance 204 are often specified and these are converted to the necessary positions or settings for the source stage 154 and detector stage 156 and/or sample stage as part of the scanning setup. The parameter calculation app 252 determines different combinations of these parameters to facilitate the user's operation of the system 200.

The present microscopy system 200 has an optical camera 210 such as a video camera that collects image data of the sample 114 held in the object holder 112. This camera is typically mounted directly or indirectly to the system base 107 via a mounting system 215, such as a bracket. Typically, optical camera 210 collects the images in the visible portion of the spectrum and/or in the adjacent spectral regions such as the infrared. Usually, the optical camera 210 has a CCD or CMOS image sensor. Also included is a light source 212 that illuminates the object in the spectral regions employed by the optical camera.

### Operation

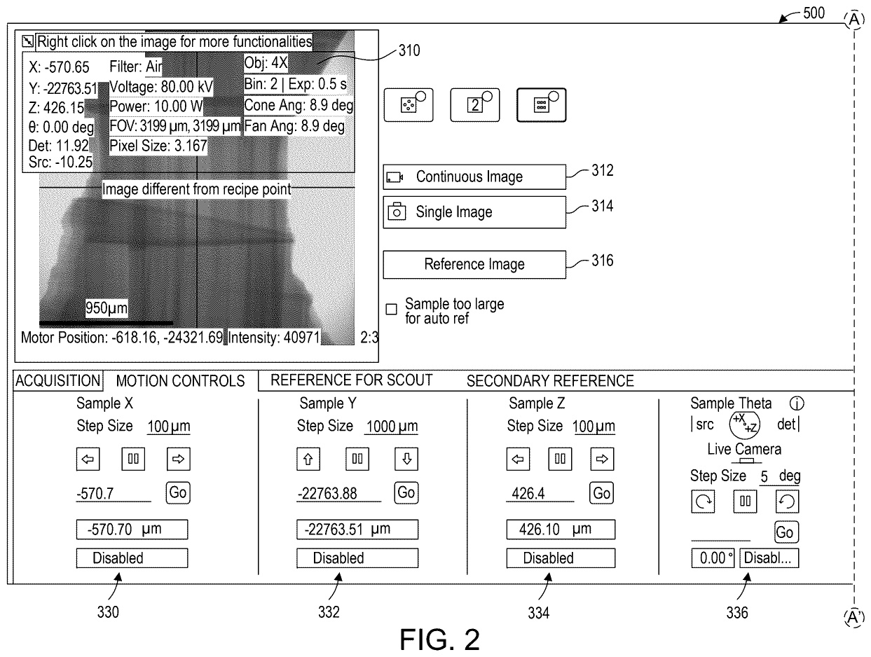

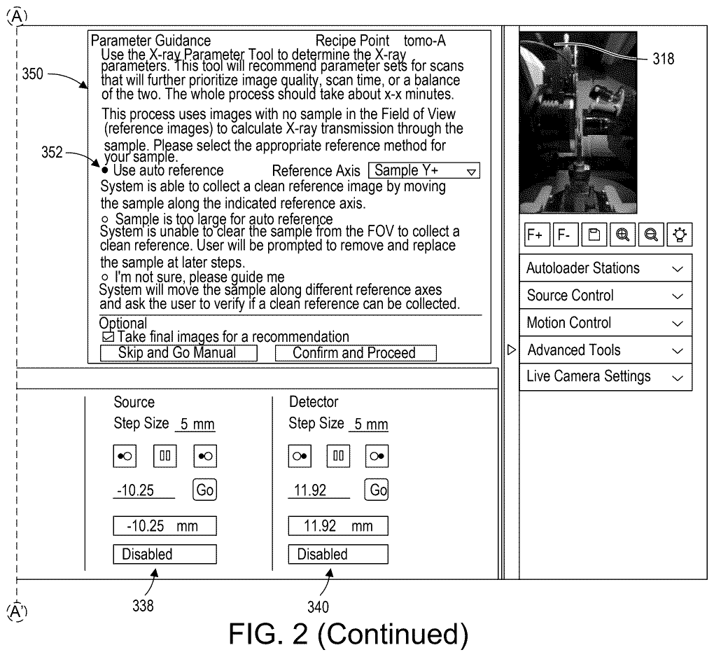

FIG. 2 shows the user interface 500 generated by the user interface app 250 executing on the operating system 262 of the computer system 224 and rendered on the display device 236.

The user interface 500 includes a projection pane 310. This presents a projection or image captured by the detector subsystems 118.

A continuous image button 312, a single image button 314, and a reference image button 316 enable the user to capture corresponding images from the XRM system 200.

The user interface 500 includes an optical camera pane 318 showing the current image data received from the optical camera 210.

A messaging pane 350 provides guidance to the user and receives user instructions for configuring the system 200.

Motion controls are located at the bottom of the window. A sample x-position control area 330 enables the movement of the object holder 112 and thus the sample or object 114 along the x-axis by control of the 3-axis stage 150, a sample y-position control area 332 enables the movement along the y-axis by control of the 3-axis stage 150, a sample z-position control area 334 enables the movement along the z-axis by control of the 3-axis stage 150, sample theta control area 336 enables the rotation of the object holder 112 and thus the sample or object 114 by control of the theta stage 152, a source position control area 338 allows for the z-axis movement of the source by control of the source stage 154, and a detector position control area 340 allows for the z-axis movement of the detector subsystem 118 by control of the detector stage 156.

As shown in FIG. 2, via the messaging pane 350 the user interface app 250 initially gives options for how the parameter calculation app 252 can acquire reference images. A radio button arrangement 352 allows for the selection between an auto reference, sample too large, or a guided approach.

An auto reference selection will move the sample according to a selected reference axis. The example shows the selection of the Y-axis, the X-axis or Z-axis can alternatively be selected. This causes the movement of the respective axis of the 3-axis stage 150 to move the sample out of the field of view to obtain the reference image.

It also provides for the situation in which the sample is too large to obtain the reference image. This occurs when the sample cannot be moved completely out of the field of view. In this case, the system will prompt the user to remove the sample 114 via the messaging pane.

Finally, the user interface app 250 of the system 200 provides for a step-by-step guidance procedure by selecting the third radio button. In this procedure, to determine the axis used to move the sample out of the way for reference images, software is designed to test different reference axes sequentially and prompt the user after each one to confirm if the current axis is sufficient.

In some implementations, the axis is determined without user prompt either from auto analysis of images or from CAD models of the system and sample.

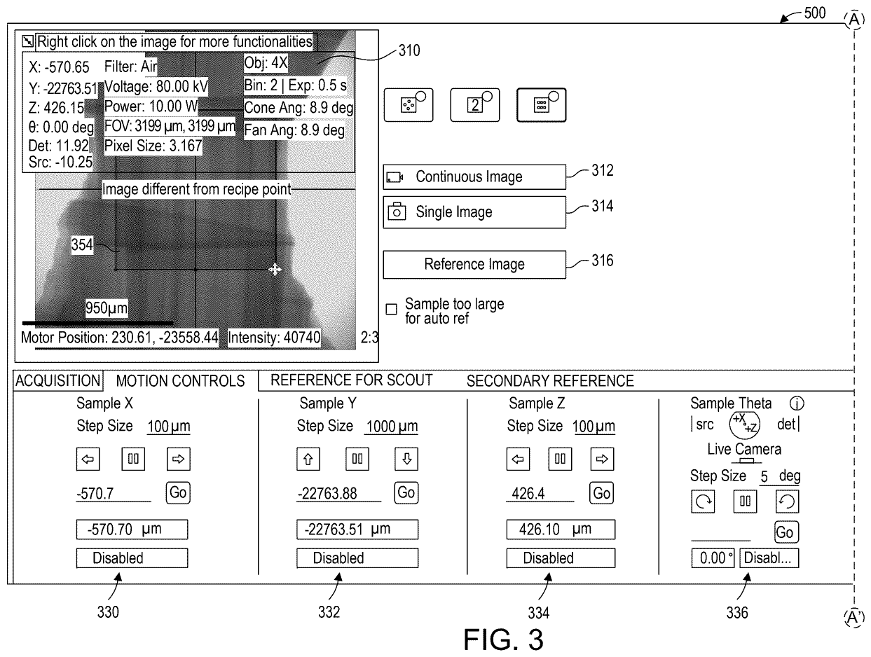

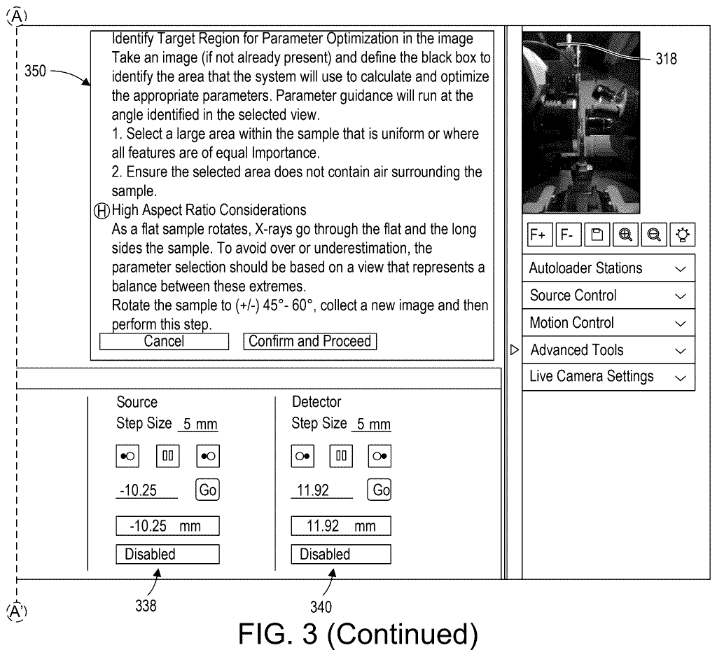

Next as shown in FIG. 3, the user interface app 250 via the messaging pane 350 guides the user to define one or more target regions of interest of the sample. In this procedure, the user is instructed to define a box in the projection pane 310 that will be used to calculate and determine the appropriate acquisition parameters. Specifically, the area should be generally uniform or where all features are of our equal importance. In addition, the selected region should not contain any air.

To facilitate this process, the projection pane 310 is provided with a region of interest overlay 354. Specifically, the user uses the user interface devices 235, e.g., computer mouse, to size the region of interest overlay 354 so that it covers the desired target region with respect to the projection being displayed in the projection pane 310. The specified region of interest will be used to determine the acquisition parameters by the parameter calculation app 252.

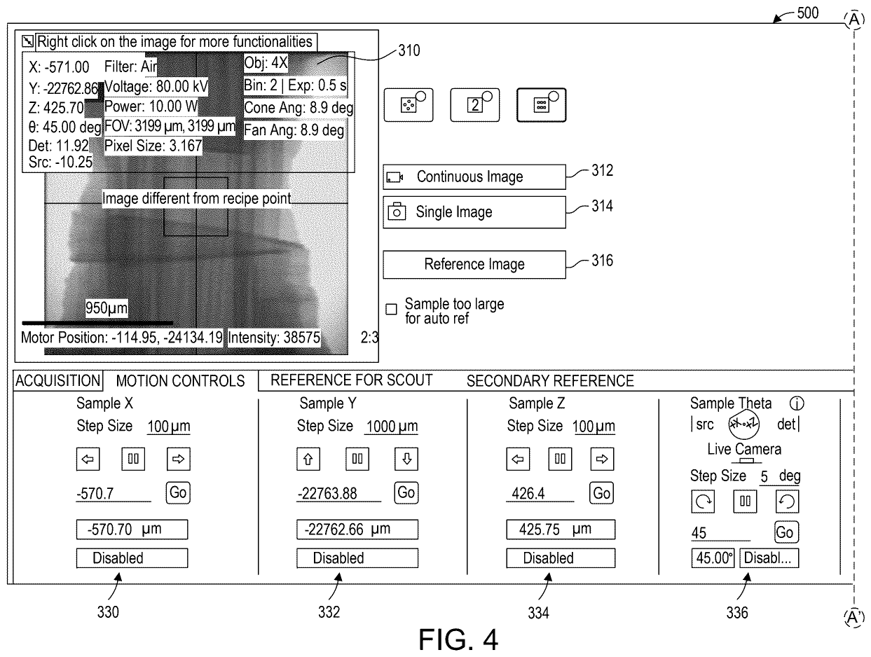

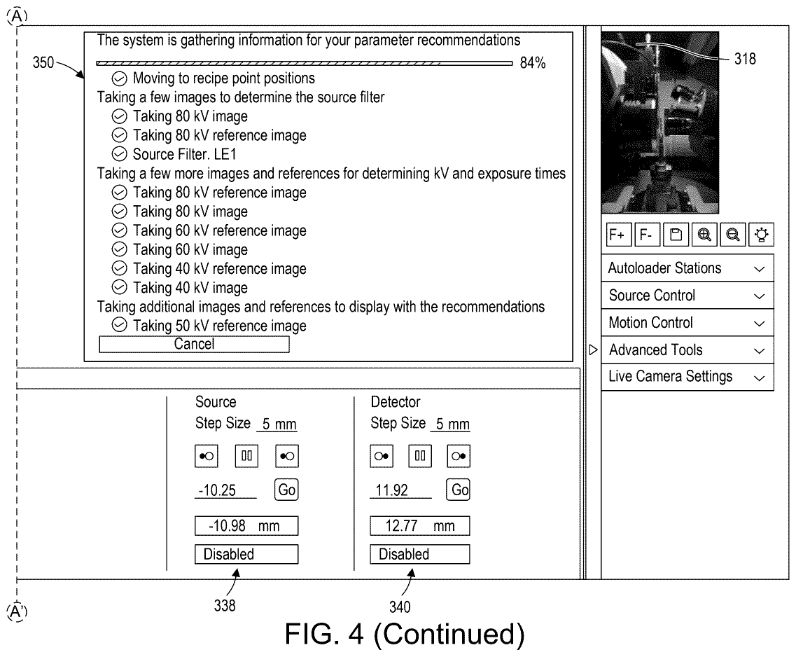

FIG. 4 shows the interface and specifically the messaging pane 350. Here, it outlines a series of steps 356 in which images are taken in order to help determine the best parameters.

First, the sample is moved to the recipe point positions and the “air” filter is applied.

An image or projection of the sample is then captured with the X-ray source set at 80 kV voltage with the air filter, followed by a reference image with the same settings. Source filter LE1 is next applied by control the filter wheel 160.

Next, 80 kV reference and sample images are taken followed by 60 k V reference and sample images followed by 40 kV reference and sample images.

Finally, if the user chose to take final images for a recommendation, a 50 kV reference image is also captured. These various images are captured automatically by the system 200 and the images are passed to the parameter calculation app 252.

In practice, the decision tree is actually quite variable after the first 80 kV, air image. For example, if the reference image was too large and ref approach was selected, the system takes a 140 kV, air image next, then asks the user to remove the sample from the system, then takes reference images at both 80 kV and 140 kV. More commonly, the 2nd image is an 80 kV, air reference image. The decision tree implemented by the system dictates whether it has enough information already to select a filter, or if it needs to take sample and ref images at 140 kV first. Post filter selection, the system is dynamically choosing what to do next based on the information it has up to that point.

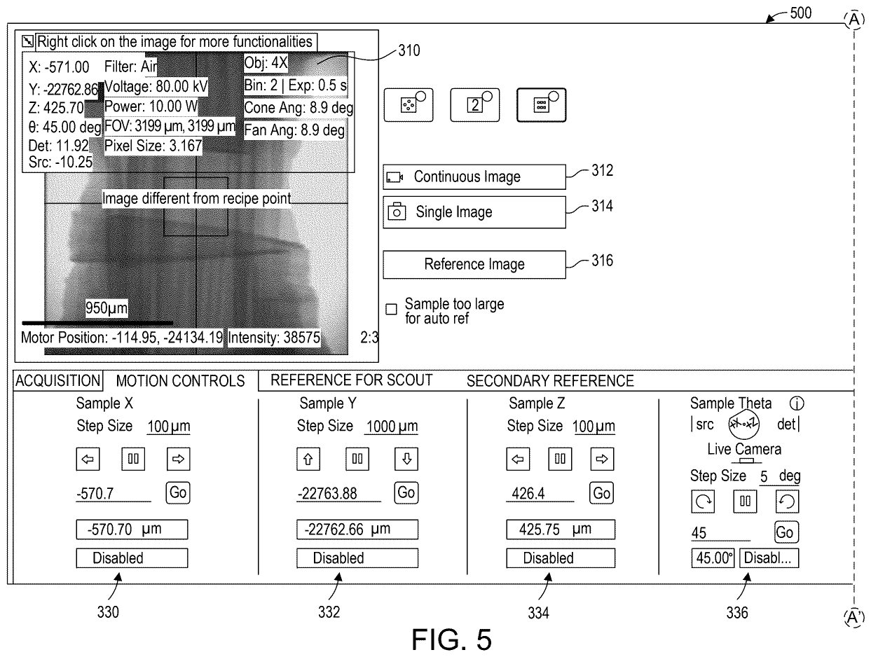

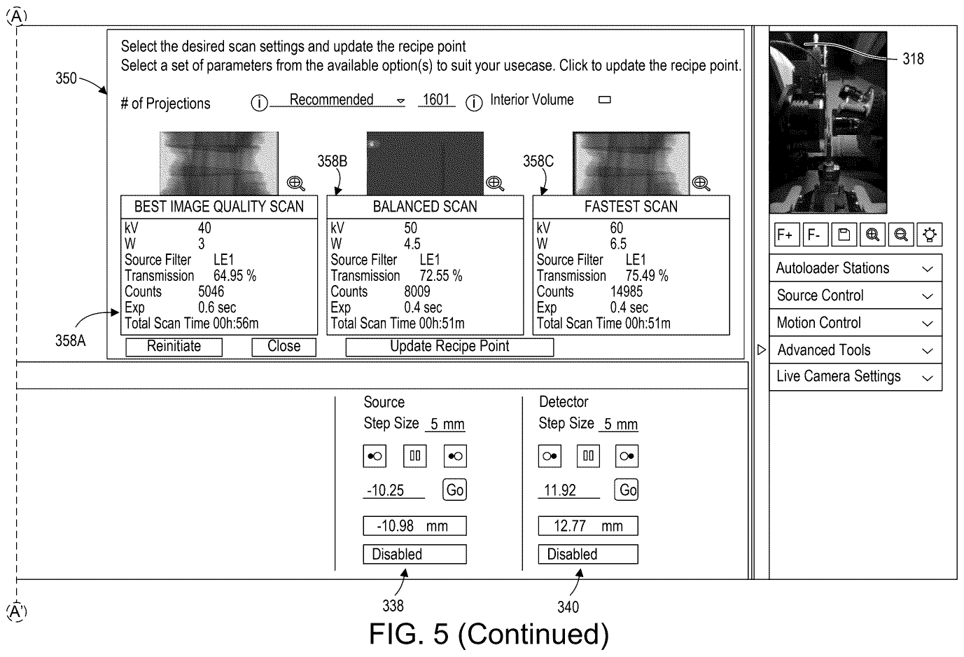

FIG. 5 shows the messaging pane 350 offering one or more different parameter setups 358A, 358B, 358C determined by the parameter calculation app 252. The first 358A will yield the best quality image scan, the last 358C will yield the fastest scan, whereas the middle parameter list 358B provides a valid scan that will optimize for both image quality and speed.

This series of images could be driven by a different decision tree, model, simulation, or machine learning.

More generally, the filter selection is based on transmission in the initial 80/140 kV images taken with the “air” filter.

For kV, a range that results in 20%-35% transmission is desired. It should be noted however, there are many cases like the one in the example where that transmission range is not possible with the selected filter, so what is shown is as close to that range as the system can achieve.

The exposure time recommendation is based on the amount of time calculated to get a median of 5000 counts in the sample image ROI (the area defined by overlay 354), in a current example. In other approaches, a better trade-off between the number of counts and number of projections can be provided. Regardless, with the current implementation there are many cases like the one in the example where 5000 counts is not best/possible due to boundary conditions defined for exposure time (a minimum limit based on camera functionality, a minimum limit to avoid shutter artifacts/avoid inefficient scans due to overhead time between projections, an upper limit to avoid saturation, and an upper limit of 90s to keep total scan times practical). Sometimes these limits are in conflict with one another, so priority of these boundary conditions is also determined.

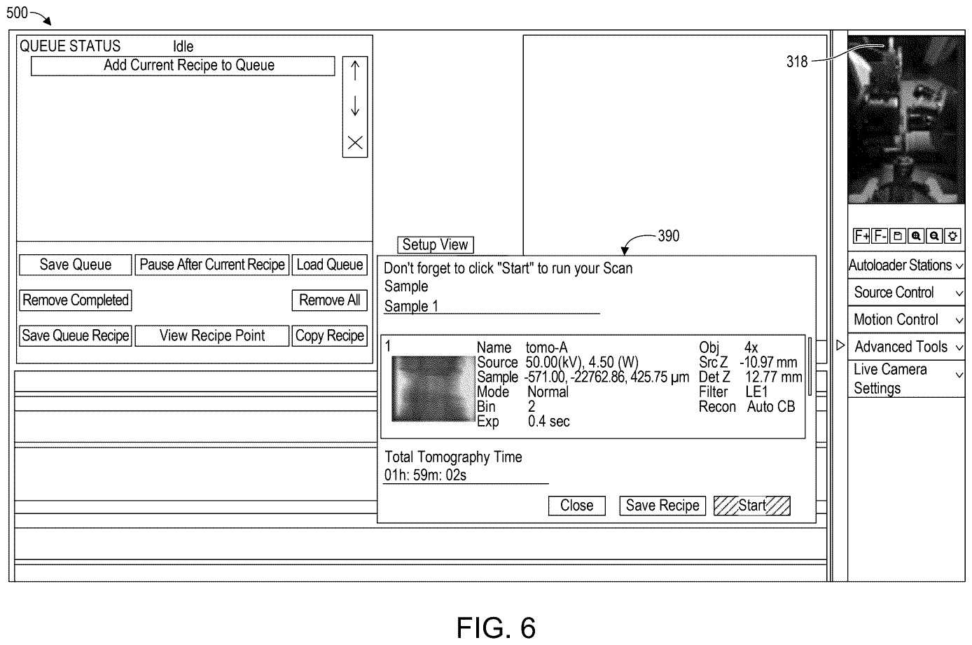

Once the user picks the desired parameter setup, then the scan is begun as shown in FIG. 6 by the status window 390.

While this invention has been particularly shown and described with references to preferred embodiments thereof, it will be understood by those skilled in the art that various changes in form and details may be made therein without departing from the scope of the invention encompassed by the appended claims.

1. An X-ray system such as an X-ray microscopy system with guided acquisition parameter selection for acquiring a computed tomography (CT), comprising:
an X-ray source subsystem of generating X-rays;
an object stage subsystem for holding a sample in the X-rays;
a detector subsystem for capturing images of the sample and reference images; and
a computer for receiving the images from the detector subsystem and generating suggested acquisition parameters for a scan.

2. The system as claimed in claim 1, wherein a user interface generated by the computer guides the user to select a method for capturing one or more reference images and guides the user to select suggested acquisition parameters.

3. The system as claimed in claim 1, wherein the user interface generated by the computer guides the user to capture one or more sample images of the sample.

4. The system as claimed in claim 1, wherein the user interface generated by the computer includes a user adjustable ROI overlay on captured sample images.

5. The system as claimed in claim 1, wherein the sample and reference images are captured at different X-ray source subsystem acceleration voltages and different filters and different exposure times.

6. The system as claimed in claim 1, wherein the computer analyzes the one or more reference images and the one or more sample images to generate suggested acquisition parameters.

7. The system as claimed in claim 1, wherein the computer suggests several acquisition parameters.

8. A method for guided acquisition parameter selection in an X-ray system such as an X-ray microscopy system, comprising:
generating X-rays;
detecting the X-rays after interaction with a sample; and
receiving images by a computer; and
guiding a user to find acquisition parameters by analyzing images.

9. The method as claimed in claim 8, wherein a user interface generated by the computer guides the user to select a method for capturing one or more reference images and guides the user to select suggested acquisition parameters.

10. The method as claimed in claim 9, wherein the user interface generated by the computer guides the user to capture one or more sample images of the sample.

11. The method as claimed in claim 9, wherein the user interface generated by the computer includes a user adjustable ROI overlay on captured sample images.

12. The method as claimed in claim 9, wherein the sample and reference images are captured at different X-ray source subsystem acceleration voltages and different filters and different exposure times.

13. The method as claimed in claim 9, wherein computer analyzes the one or more reference images and the one or more sample images to generate suggested acquisition parameters.

14. A user interface rendered on a display of a microscopy system, comprising:
controls for moving a source stage and/or object stages and/or a detector stage; and
a messaging region in which acquisition parameters are suggested.
